(19) United States
(12) Patent Application Publication
(10) Pub. No.: US 2007/0106663 A1
(43) Pub. Date: May 10, 2007

(54) METHODS AND APPARATUS FOR USING USER PERSONALITY TYPE TO IMPROVE THE ORGANIZATION OF DOCUMENTS RETRIEVED IN RESPONSE TO A SEARCH QUERY

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: OUTLAND RESEARCH, LLC, Pismo Beach, CA (US)

(21) Appl. No.: 11/619,605

(22) Filed: Jan. 3, 2007

Related U.S. Application Data
(63) Continuation-in-part of application No. 11/298,797, filed on Dec. 9, 2005.
(63) Continuation-in-part of application No. 11/341,021, filed on Jan. 27, 2006.
(60) Provisional application No. 60/649,240, filed on Feb. 1, 2005.
(60) Provisional application No. 60/754,387, filed on Dec. 27, 2005.
(60) Provisional application No. 60/781,685, filed on Mar. 13, 2006.

(51) Int. Cl. G06F 17/30

(52) U.S. Cl. 707/5

(57) ABSTRACT

A user's document preferences are affected by his or her personality. The present invention provides improved organization of documents collected in response to a search query based at least in part upon identified Personality Type data of the user performing the search and Personality Usage Data collected from a plurality of other users who previously accessed said documents. A search query is received from a user along with personality information for that user. In response to said query, a list of responsive documents is identified and organized based at least in part upon one or more personality characteristics of the user performing the search and a correlation with Personality Usage Data for the responsive documents. As used herein, Personality Usage Data for a particular document comprises a tally and/or frequency of users who previously accessed that document for each of a plurality of different personality characteristics and/or combinations of characteristics.

This application is a continuation-in-part of U.S. patent application Ser. No. 11/298,797 filed Dec. 9, 2005, which claims the benefit of U.S. Provisional Patent Application No. 60/649,240 filed Feb. 1, 2005, and is a continuation-in-part of U.S. patent application Ser. No. 11/341,021 filed Jan. 27, 2006, which claims the benefit of U.S. Provisional Patent Application No. 60/754,387 filed Dec. 27, 2005, all of which are incorporated in their entirety herein by reference.

This application also claims the benefit of U.S. Provisional Patent Application No. 60/781,685 filed Mar. 13, 2006, which is incorporated in its entirety herein by reference.

### BACKGROUND OF THE INVENTION

1. Field of the Invention

The present invention relates generally to internet search engines and, more particularly, to employing data related to a user's personality type to improve information search, retrieval, and organization, during internet searching.

2. Discussion of the Related Art

The World Wide Web (“web”) contains a vast amount of information, including large amounts of information on most topics of interest. For example, a particular topic of interest may be addressed by many thousands of documents, each of which approaches the topic from a differing perspective. Locating a desired document among the large numbers of documents can be quite challenging, especially for a topic that is broad, popular, and/or may be addressed from a great many perspectives. This problem is compounded because of the great diversity of users who are currently using the web and searching for similar documents, each of whom may have very different opinions as to which documents covering a particular topic are most preferred.

In general, automated search engines locate web sites by matching search terms entered by the user to an indexed corpus of web pages. Generally, the search engine returns a list of web sites sorted based on relevance to the user's search terms. Determining the correct relevance, or importance, of a web page to a user, however, can be a difficult task. Conventional methods of determining relevance are based on matching a user's search terms to terms indexed from web pages. More advanced techniques determine the importance of a web page based on more than the content of the web page. For example, one known method, described in the article entitled “The Anatomy of a Large-Scale Hypertextual Search Engine,” by Sergey Brin and Lawrence Page, assigns a degree of importance to a web page based on the link structure of the web page. Another known method is disclosed in U.S. patent application No. 2002/0123988 as published on Sep. 5, 2002 and is hereby incorporated by reference into this specification.

Each of these methods has shortcomings, however. Term-based methods are biased towards pages whose content or display is carefully chosen towards the given term-based method. Thus, they can be easily manipulated by the designers of the web page. Link-based methods have the problem that relatively new pages have usually fewer hyperlinks pointing to them than older pages, which tends to give a lower score to newer pages. There exists, therefore, a need to develop other techniques for determining the importance of documents when ordering documents in response to a search query.

### SUMMARY OF THE INVENTION

Several embodiments of the invention advantageously address the needs above as well as other needs by providing methods and apparatus for using data related to a user's gender to improve the organization of documents retrieved in response to a search query.

In one embodiment, the invention can be characterized as a computer implemented method of organizing a set of documents retrieved in response to a search query, the method comprising receiving a search query from a user; obtaining an identified personality type for the user, the identified personality type classifying the user with respect to one or more personality characteristics; identifying a set of documents responsive to the search query; assigning a score to each identified document based upon a correlation between personality-usage data for each document and the identified-personality type of the user, the personality-usage data for each document describing at least one of a number, frequency, and percentage of users who have previously accessed the document who are deemed to possess one or more particular personality characteristic classifications; and organizing the documents based at least in part on the assigned score.

In another embodiment, the invention can be characterized as a computer implemented method of organizing a set of documents retrieved in response to a search query, the method comprising: receiving a search query from a user; obtaining identified personality type data for the user, the identified personality type data classifying the user with respect to one or more personality characteristics; identifying a set of documents responsive to the search query; assigning a score to each identified document based upon a correlation between the identified-personality type data of the user and stored data associated with the document, the stored data indicating how user partiality towards the document is likely to be influenced by one or more user personality characteristic classifications; and organizing the documents based at least in part on the assigned score.

In a further embodiment, the invention can be characterized as a computer implemented method of organizing a set of documents retrieved in response to a search query, the method comprising: receiving a search query from a user; obtaining identified personality type data for the user, the identified personality type data classifying the user with respect to one or more personality characteristics; identifying a set of documents responsive to the search query; assigning a score to each identified document based upon a correlation between the identified-personality type data of the user and stored data associated with the document, the correlation indicating a degree of partiality that the user is likely to have towards the document as a result of the user's classification with respect to one or more personality characteristics.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a diagram illustrating an exemplary network in which concepts consistent with the present invention may be implemented;

FIG. 2 illustrates an exemplary client device of the present invention;

FIG. 3 illustrates an example flow diagram for organizing documents based in part on personality information for a user who performs a search and the retrieved documents;

FIG. 4 illustrates an example process flow for accessing, updating, processing, and storing Personality Usage Data for a particular document;

FIG. 5 depicts an exemplary document ordering process consistent with the invention;

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

A user's personality type may be used to improve information search, retrieval, and organization, during internet searching. In general, a user's personal document preferences are affected by many factors, including characteristics of his or her personality. For example, some users may prefer documents that address an issue from a highly factual and analytical perspective while other users may prefer documents that offer more a qualitative description of a topic and addresses how people feel about issues rather than just the facts surrounding the issues. According to modern Personality Theory, informational preferences such as the difference between preferring facts or feelings, is a direct result of a user's personality characteristics. As a result, personality differences between users are likely to cause them to have differing preferences with respect to document retrieval when using a search engine, even when searching the same or similar topics.

What is therefore needed are methods and apparatus that enable internet searches to be performed with consideration of the personality type and/or qualities of the user who is performing the search when ordering and presenting search results for that user. Unfortunately automated search engines such as Google and Yahoo of the prior art do not currently account for the personality of the searcher.

Conventional methods do not account for statistically predictable similarities and/or differences between users who initiate a search when ordering the results for those users. For example, a user of a particular personality type is likely to prefer substantially different documents in response to certain search queries as compared to a user of an alternate personality type who enters the same queries. At the same time, people of the same or similar personality type are more likely to prefer more similar documents. This is because people of the same or similar personality type are more likely to have similar preferences in how they receive, process, and judge information.

There exists, therefore, a substantial need to develop new techniques for ordering documents in response to a search query that account for statistically predictable similarities and/or differences between users based upon their personality type and/or personality characteristics. The present invention addresses these and other needs by providing methods and techniques for ordering documents in response to search query that utilize the statistically predictable differences and/or similarities in document preferences based upon user's personality and the personality of other users who have previously accessed those web documents.

Background on Personality Theory

Modern personality theory is generally based upon the founding work of Carl Jung it was as later extended by Katharine Cook Briggs and Isabel Briggs Myers. While there are various ways in which personality theory may be used to quantify individuals with respect to personality classifications, a commonly accepted paradigm states that the general human population can be segmented based upon four distinct and separable personality measures. There are a number of ways in which these four measures may be described, but they generally represent the following four characteristics:

(1) How a person prefers to orient themselves to the world. This is a measure of whether or not a person prefers to deal with the external world of people and situations or the internal world of personal thoughts and ideas. It is generally includes a measure of whether of someone is a social extrovert or a private introvert.

(2) How a person prefers to take in information from their world. This is a measure of whether or not a person prefers crisp facts about their world or if a person is more comfortable developing intuitive feelings about their world. This also relates to whether a person is more comfortable dealing with the present through direct sensing or dealing with the future through imagination and intuition.

(3) How a person prefers to makes decisions about their world. This is a measure of whether a person prefers to make decisions based upon careful analysis and logic, or whether a person prefers to make decisions based upon their feelings and the feelings of others around them. This generally represents the difference between thinking things out when making decision or going with feelings about the consequences.

(4) How a person prefers to structure information in their world. This is a measure of whether a person prefers to deal with events and information in a structured manner that involves clear plans and rigorous judgments, or being more flexible to take things as they come, living a more receptive mode based upon how the world is perceived.

These metrics are often assessed as dichotomies, meaning they can be assessed as a binary classification for each of the four categories. Alternately these metrics can be assessed as continuous values on a scale for each category; each metric being assigned a value somewhere between two ends of a spectrum. Either way, each of the four measures is generally defined by two opposing sets of characteristics that represent the dominant personality traits for that measure. The four opposing sets of personality characteristics are often represented by the following words:

(1) EXTRAVERTED versus INTROVERTED

(2) SENSING versus INTUITIVE

(3) THINKING versus FEELING

(4) JUDGING versus PERCEIVING

Each of the bold words is a name given to represent of a set of personality characteristics that defines one end of the spectrum for each of the four personality categories. In many personality classification systems, the pure dichotomy is used, assigning one of the above words in each category to a particular person. In this way a person may be assigned a personality type of: (Extraverted, Sensing, Feeling, Judging). This is often represented by a shorthand that just uses one letter of each (ESFJ). Other systems define values upon a scale for each or assess things using slightly different formats. Regardless of the personality classification system used, the basic method is to quantify an individual based upon one or more personality characteristics. In this way the general population of individuals can be segmented into subpopulations by personality classification. In the common system described above, which is generally referred to as the Myers-Briggs Personality Classification System, the use of dichotomies in each of the four categories creates the possibility for 16 different personality type definitions. Thus the Myers-Briggs Personality Classification System can be used to segment the general population into 16 different subpopulation. Other systems offer greater or fewer segmentations. Some systems described the segmentations as different Personality Types while other systems describe the segmentation as different Cognitive Styles. Such words are often used interchangeably to mean the same or similar things. Additional descriptions of personality types can be found at http://www.personalitypathways.com which is hereby incorporated by reference.

As used herein, a defined set of two opposing personality characteristics for a particular aspect of a person's personality is referred to as a dichotomy. As also used herein the selected set for a given user is referred to herein as a Dichotomy Assignment. Thus under the Myers-Briggs personality typing paradigm, each person is generally given a set of four Dichotomy Assignments, these four binary values defining a possible set of 16 different high level Personality Types for the user population. Other typing paradigms may define greater or fewer different types. In addition, other paradigms may use values on a scale rather than dichotomies.

Thus modern Personality Theory contends that each individual has basic personality characteristics that can be quantified, enabling the general population to be segmented into sub-populations based upon each individuals more likely tendencies and behaviors. For example, each of us generally prefers to behave in a more Extraverted or Introverted way. Of course some individuals may only mildly favor one mode of behavior over the other while others may dramatically favor one mode over the other. That said, the tools provided by modern Personality Theory do enable an effective classification system for most individuals that can be used to help make predictions about those individuals. For example career planning, team building, and even matching individuals for romantic relationships can be performed based at least in part upon the results of a personality classification test.

The present invention is directed at employing personality classification of individuals in totally new and different domain. More specifically, the present invention is directed at employing personality classification measures in the ordering of documents retrieved in response to an internet search query. In this way, the present invention is directed at assisting a user in finding documents over the internet that he or she is statistically more likely to prefer based upon his or her personality tendencies. Such a usage as disclosed herein is potentially of extreme value, for when users search for documents over the internet, a typical search engine may find hundreds or thousands or even hundreds of thousands of target documents that meet the criteria of a particular search query. It is therefore of great importance that a search engine be provided with rapid and intelligent methods by which the identified documents may be ordered for a particular user. A variety of methods are currently used for ordering documents, for example consideration to the overall usage of documents among internet users—the more popular documents (i.e. the documents that are accessed the most often), are generally ordered preferentially with respect to documents that are not accessed often. Such methods, however, do not account for taste differences among individuals based upon their personality differences and cognitive styles. The present invention addresses this deficiency in modern search engines by ordering documents with consideration of not just overall usage, but usage that is segmented based at least in part upon an identified personality type of internet users. Thus the present invention comprises methods and apparatus for ordering a plurality of documents retrieved in response to a search query with consideration of personality classification information for the user performing the search and for previous users who accessed the plurality of retrieved documents.

The present invention addresses the aforementioned needs by using an identified Personality Type of the user who initiates an internet search to better organize the search results presented to that user. As used herein, Personality Type is a single-dimensional or multi-dimensional metric by which individuals of a population may be quantified and/or categorized based upon their personality related traits and tendencies. The Myers-Briggs Personality Type system is used herein as the primary example because of its popularity and acceptance although other personality typing systems could be used in addition to or instead of the Myers-Briggs system. In general, the present invention is focused upon those personality characteristics that affect how a person may prefer to receive, process, and/or judge information. This is because such personality characteristics are most likely to affect the types of documents that a user will prefer. For example, how a person prefers to make decisions when provided with information is a personality trait that is likely to affect the kinds of documents that user would most likely receive and review then performing an internet search. The Personality Type of an individual user may be determined by user survey (i.e. by a standardized personality test performed by having the user answer directed questions) and/or by other predictive means, for example based upon an analysis of the types of documents the user has historically preferred.

One aspect of the present invention is directed to methods of organizing a set of documents by receiving a search query and identifying a plurality of documents responsive to the search query. Each identified document is assigned a score based in whole or in part upon a degree of correlation between an Identified Personality Type for the user and Personality Usage Data that is relationally associated with the document, the documents are organized based on the assigned scores. In one embodiment the Identified Personality Type of the user includes a single quantified personality characteristic for the user. In another embodiment the Identified Personality Type of the user includes a set of quantified personality characteristics for the user. In some embodiments the Identified Personality Type may also include a Personality Correlation Factor that is stored and indicates the degree of statistical relevance that one or more personality characteristics has for the particular user. In one such embodiment the Personality Correlation Factor is a number between 0 and 1 that indicates a degree of statistical relevance that one or more personality characteristics has to predicting the document preference of that user, the larger the number the more statistical relevance. For example, in some users personality type may be highly relevant in predicting the documents that the user may prefer. For such a user, the Personality Correlation Factor may be set to 0.88, for example. In other users, personality type may be mildly relevant in predicting the documents that a user may prefer. For such a user the Personality Correlation Factor may be set to 0.24, for example. In other embodiments, no Personality Correlation Factor is used.

Another aspect of the present invention is directed to a method of organizing a set of documents by receiving a search query and identifying a plurality of documents responsive to the search query. Each identified document is assigned a score based in whole or in part upon a degree of correlation between an Identified Personality Type for the user and Personality Usage Data that is relationally associated with the document AND a degree of correlation between an Identified Gender for the user and Gender Usage Data that is relationally associated with the document, the documents are then organized based on the assigned scores. In this way the combined affect of Personality and Gender upon predicted document preference may be used to better order the documents in response to a search query. In some such embodiments Personality and Gender correlations are equally weighted in their affect upon document ordering. In other embodiments, weighting factors are used such that Personality and Gender correlations have differing amounts of affect upon document ordering.

Another aspect of the present invention is directed to a method of organizing a set of documents by receiving a search query and identifying a plurality of documents responsive to the search query. Each identified document is assigned a score based in whole or in part upon a degree of correlation between an Identified Personality Type for the user and Personality Usage Data that is relationally associated with the document AND a degree of correlation between an Identified Age Group for the user and Age Usage Data that is relationally associated with the document, the documents are then organized based on the assigned scores. In this way the combined affect of Personality and Age upon predicted document preference may be used to better order the documents in response to a search query. In some such embodiments Personality and Age correlations are equally weighted in their affect upon document ordering. In other embodiments, weighting factors are used such that Personality and Age correlations have differing amounts of affect upon document ordering.

Another aspect of the present invention is directed to a method for using all three of Identified Age Group, Identified Gender, and Identified Personality Type in whole or in part when ordering the documents presented to a user in response to a search query.

Another aspect of the present invention is directed to a method of predicting the Personality of a particular user based at least in part upon correlations between that user's document preferences and stored Personality Usage Data for a plurality of documents.

In many common embodiments of the present invention, a search query is received and a list of responsive documents is identified. The list of responsive documents may be based on a comparison between the search query and the contents of the documents, or by other conventional methods of the art. Identified Personality Type data is also accessed, either from a store of data in local or remote storage, or through one or more queries provided to the user prior to or during the search. In one embodiment, for example, the Identified Personality Type data includes data indicating one or more personality classifications for the user. If a Myers-Briggs personality typing paradigm is being used, this one or more personality classifications would include a Dichotomy Assignment for at least one of the four personality characteristic metrics used by the paradigm. In some embodiments the Personality Type data would include a Dichotomy Assignment for all four personality characteristic metrics used by the paradigm. In such an example, these four definitions could combine to describe one of sixteen possible high level personality types. Thus the Identified Personality Type Data may include a coded representation of each of the four dichotomy assignments or may include a single code to represent one of the 16 possible combinations of dichotomy assignments. For example, the Personality Type data may include a code which corresponds to the personality type ESFJ, indicating that the particular user has been classified as Extrovert, Sensing, Feeling, and Judging, in each of the four Myers-Briggs personality characteristic metrics respectively.

It is important to note that the current invention need not access and use all of the metrics used by a particular personality typing paradigm. For example, in the example above the invention need not access and use all four of the Myers-Briggs metrics. Also, while the above example uses binary dichotomy assignments for each metric, other paradigms may be used that employ values on a scale for each metric. That said, for simplicity of explanation the description of the invention herein will focus upon example embodiments in which the Myers-Briggs paradigm is used, each metric is represented as a dichotomy, and all four dichotomy assignments are employed to define one of sixteen high level Personality Types for each user.

As defined herein, the Identified Personality Type data for an individual may include additional information beyond the actual personality classification values for that user. For example, in some preferred embodiments the Identified Personality Type data also includes a Personality Correlation Factor that indicates the degree of statistical relevance that personality type has for predicting the document preference for that particular user. In one such embodiment the Personality Correlation Factor is a number between 0 and 1 that indicates a degree of statistical relevance that personality type has to document preference for that user. For example, for some users personality type may be highly relevant in predicting the documents that the user may prefer. For such a user, the Personality Correlation Factor may be set to 0.90 for example. For other users, personality type may be mildly relevant in predicting the documents that a user may prefer. For such a user the Personality Correlation Factor may be set to 0.27 for example. In other embodiments, no Personality Correlation Factor is used.

In addition to the steps above, the current invention also includes methods and systems for storing and processing data related to web page usage, said data referred to generally as usage data. Typically usage data includes information about a web page that describes how many users visited the page (perhaps over a period of time) and/or how often users visited the page (perhaps over a period of time). As disclosed in this invention, a new form of usage data referred to herein as Personality Usage Data is employed. Personality Usage Data not only represent how often a particular web page is accessed, but also correlates the Identified Personality Type characteristics of those users who have accessed a web page with usage. In this way the power of usage data can be substantially expanded, recording not just how often a web page is accessed, but how often it is accessed by users of particular personality characteristics. For example, an embodiment that employs the Meyer-Briggs personality typing paradigm may be configured to store usage data correlating with each Dichotomy Assignment used by the paradigm. In this way, the Personality Usage Data of the present invention may record how many times and/or how often a particular web document has been accessed, for example, by users who have an Intuitive personality characteristic. Similarly, the Personality Usage Data of the present invention may also record how many times and/or how often a particular web document has been accessed by users who have a Feeling personality characteristic. In fact a similar record may be kept for each of the 8 different dichotomy assignments used by personality typing paradigm. Note—because these values operate in pairs in the Meyer-Briggs paradigm (i.e. a user can either be defined as Intuitive or Sensing, but not both), the data can be represented in a condensed form such that only one value is stored for each dichotomies. For example, a Percent_Intuitive value may be stored indicating the percentage of personality-classified users who have accessed a particular document who have a personality classification of Intuitive. If this value were 65%, the converse of this value (i.e. 35%) would indicate the percentage of users who accessed that particular document who had a classification of Sensing. Thus a single dichotomy may be represented as a single stored value. In this way the full Myers-Briggs paradigm may be represented for each document as four stored values.

In some common embodiment of the present invention, Personality Usage Data includes data that indicates the number of users who have visited a particular internet site or document who have been identified as having each of a plurality of different personality classifications. In the most general case, variables are established for each personality classification being tracked—for example, EXTRAVERTED, INTROVERTED, SENSING, INTUITIVE, THINKING, FEELING, JUDGING, and PERCEIVING. For each of these personality classifications a tally variable may be established, storing the number of users who have visited the site (i.e. accessed the document) who have personality assignments from each of the plurality of personality classifications being tracked. In some embodiments the tally is ongoing. In some embodiments the tally is for a certain time period. In some embodiments a tally is computed for each of a plurality of time windows. In one example embodiment the tally indicates the number of users who have visited the site over the previous 15 days who have personality assignments from each of the plurality of personality classifications being tracked. For example, a plurality of tally variable may be established and maintained including Tally_EXTRAVERTED, Tally_INTROVERTED, Tally_SENSING, Tally_INTUITIVE, Tally_THINKING, Tally_FEELING, Tally_JUDGING, and Tally_PERCEIVING. Each of these variables stores the number of users who have visited the site over the previous 15 days who were identified as having of each the respective personality characteristics above. Thus the Tally_INTROVERTED piece of Personality Usage Data for a particular document is a store of the number users who accessed that particular document over the internet during the 15 day time period who was classified as being INTROVERTED by the personality typing paradigm. Similarly the Tally_INTUITIVE piece of Personality Usage Data for a particular document is a store of the number of users who accessed that particular document over the internet during the 15 day time period who was classified as being INTUITIVE by the personality typing paradigm.

In other embodiment, Personality Usage Data includes data that indicates the rate or frequency of user visits to a particular site or document from users who have been identified as having each of a plurality of different personality classifications. In the most general case, variables are established for each personality classification being tracked—for example, EXTRAVERTED, INTROVERTED, SENSING, INTUITIVE, THINKING, FEELING, JUDGING, and PERCEIVING. For each of these personality classifications a frequency variable may be established, storing the rate or frequency of users who have visited the site (i.e. accessed the document) who have personality assignments from each of the plurality of personality classifications being tracked. In some embodiments the frequency is an average for a certain time period, such as an average number of visits per day to the site from users of a particular personality characteristic over a certain time window. Thus a plurality of frequency variable may be set up including Freq_EXTRAVERTED, Freq_INTROVERTED, Freq_SENSING, Freq_INTUITIVE, Freq_THINKING, Freq_FEELING, Freq_JUDGING, and Freq_PERCEIVING. Each of these variables may be configured to store the average number of visits per day (over the last six months) to the particular document from users were of each the respective personality characteristics. Thus the Freq_INTROVERTED piece of Personality Usage Data for a particular document may be defined as a store of the average number of user per day who accessed that particular document during the last six months who were classified as INTROVERTED by the personality typing paradigm being used. Similarly the Freq_INTUITIVE is a piece of Personality Usage Data for a particular document is a store of the average number of users per day who accessed that particular document over the last six months who were classified as INTUITIVE by the personality typing paradigm being used.

While the Personality Usage Data is described above in terms of number of visits and/or frequency of visits from users of particular identified personality classifications, other mathematical representations may be employed. For example PERCENTAGE statistics may be stored, the percentage statistics indicating the percentage of users who have visited a particular site during a particular period of time who are of a particular personality classification. Such percentage statistics are convenient because they enable easy comparison between data points. For example the Personality Usage Data may indicate that 88% of users who visited a particular document were JUDGING while only 12% were PERCEIVING. In this way, both tally usage statistics and frequency usage statistics may be represented in percentage form.

By determining and storing Personality Usage Data as described above for a plurality of documents, the methods and systems of the present invention can be used to improve the ordering of documents provided in response to an internet search performed by a user based upon that user's Identified Personality Type. In some such embodiments, each of a plurality of identified document are assigned a score based in whole or in part upon a degree of correlation between the Identified Personality Type for that particular user and Personality Usage Data associated with that document. The plurality of documents are then organized based at least in part upon the assigned scores. In this way the affect of a user's personality classification may be used to better order the documents retrieved in response to the search query. In some such embodiments the scores and/or the importance of the scores used in the ordering of said documents are moderated by a Personality Correlation Factor for the user. For example the scores will have a large impact upon the ordering of documents for a user that has a high Personality Correlation Factor. Conversely the scores will have a smaller impact upon the ordering of documents for a user that has a low Personality Correlation Factor. Note—on some embodiments a Personality Correlation Factor is not used.

As an example of the above process, a user makes a query to a search engine who has Identified Personality Type data that identifies him or her as SENSING. In general this means that the user's personality makes him or her more likely to prefer receiving information in the forms of crisp facts rather than fuzzy feelings. The present invention makes use of this personality identification, ordering documents based at least in part upon the fact that the user's Identified Personality Type includes the SENSING assessment. To achieve a desirable ordering of search results based upon the SENSING identification for the user performing the search, the present invention may perform an ordering process based in whole or in part upon the relative frequency and/or number of times that other users who were also identified as SENSING have previously accessed some or all of the web documents identified by the search engine as compared to users of other personality traits. In other words, the ordering of the search results presented to that user may be based in whole or in part upon how significantly SENSING users are represented within the Personality Usage Data for some or all of the identified documents. In this way, the Identified Personality Type data of the user is used in conjunction with Personality Usage Data associated with each of some or all of the documents retrieved in the search to better order and present the search results to that user. In some such embodiments, each of a plurality of identified document responsive to the search are each assigned a score based in whole or in part upon a degree of correlation between one or more aspects of the Identified Personality Type of the user performing the search (i.e. the fact that the user was identified as SENSING) and one or more aspects of the Personality Usage Data associated with that document (i.e. the number and/or frequency of other users who previously accessed that document who also were identified as SENSING). The plurality of documents are then organized based at least in part upon the assigned scores for each. In this way one or more traits of a user's personality is used to order the documents retrieved in response to the search query.

In another example embodiment, a search query is received and a list of responsive documents is identified. The list of responsive documents may be based on a comparison between the search query and the contents of the documents or by other search methods known to the current art. Identified Personality Type data is also accessed for the user who performs the search, either from a store of data in local or remote storage, or through query to the user prior to or during the search. In one embodiment, for example, the Identified Personality Type data includes data indicating that the user's personality includes the identified characteristics of INTUITIVE, FEELING, and PERCEIVING. The Identified Personality Type data may also includes a Personality Correlation Factor that indicates the degree of statistical relevance that one or more personality characteristics has upon predicting the document preference for that particular user. In one such embodiment the Personality Correlation Factor is a number between 0 and 1 that indicates a degree of statistical relevance that the user's personality characteristics (i.e. the fact that he has been identified as INTUITIVE, FEELING, and PERCEIVING) has upon document preference for that particular user. This correlation factor may be derived based upon his interest in and/or satisfaction with past search results through a feedback method to be described later in this document. If an analysis of past data indicates that identified personality is a highly relevant factor in predicting the documents that this particular user may prefer, the Personality Correlation Factor may be set, for example, to 0.88 for that user. If on the other hand, an analysis of past data indicates that identified personality is only mildly effective in predicting the documents that this particular user may prefer, the Personality Correlation Factor may be set, for example, to 0.24 for that user. In this way, differing values for Personality Correlation Factor may be used to account for the fact that a user's identified personality characteristics may be of differing importance when ordering documents for different users. This is especially true when other factors are used in combination with a user's personality, such as a user's AGE and GENDER, when ordering documents. In such cases the Personality Correlation Factor allows the relative importance of personality to be adjusted with respect to other factors that may be used in ordering documents for that user. NOTE—in some embodiments a separate Personality Correlation Factor may be defined for each of a plurality of different identified personality characteristics for a user. This is because some personality characteristics may be more predictive for document preference for that user than others. For example, a separate Personality Correlation Factor may be defined for each of the identified personality characteristics (i.e. INTUITIVE, FEELING, and PERCEIVING) for the user of the above example.

In addition to the steps outlined above, the present invention may also include methods and systems for storing and processing additional unique forms of usage data in combination with Personality Usage Data as a means of better ordering documents responsive to a search query. As disclosed in co-pending U.S. application Ser. No. 11/341,021 filed by the present inventor and which has been incorporated by reference, Age Usage Data and Gender Usage Data may be collected for users who access a particular internet document, thereby documenting how usage interest in a particular document may vary statistically by the age group and/or by the gender of users. As disclosed in the aforementioned patent application, this data may be used along with Identified Age Group Data and/or Identified Gender Data for the user to better order documents retrieved in response to a search request. As disclosed herein, Personality Usage Data may be used in combination with other forms of usage data, including Age Usage Data and/or Gender Usage Data as mentioned above, to better order documents retrieved in response to a search query. For example, in some embodiments of the present invention, both Identified Personality Type data for the user and Identified Gender data for the user are used together, at least in part, to order the documents that are retrieved in response to a search query. More specifically, Identified Personality Type data is used in combination with Personality Usage Data and Identified Gender data is used in combination with Gender Usage Data to order the documents that are retrieved in response to a search query. Even more specifically, each of a plurality of identified documents is assigned a score based in whole or in part upon a degree of correlation between an Identified Personality Type for the user and Personality Usage Data associated with the document AND a degree of correlation between an Identified Gender for the user and Gender Usage Data associated with the document. The documents are then organized based at least in part upon the assigned scores. In this way the combined affect of a users Personality and Gender upon a user's predicted document preference may be used to better order the documents in response to a search query. In some such embodiments Personality and Gender correlations are equally weighted in their affect upon document ordering. In other embodiments, weighting factors are used such that Personality and Gender correlations have differing amounts of affect upon document ordering.

As another example, in some embodiments of the present invention, both Identified Personality Type data for the user and Identified Age data for the user are used together to order the documents that are retrieved in response to a search query. Specifically, Identified Personality Type data is used in combination with Personality Usage Data and Identified Age data is used in combination with Age Usage Data to order the documents that are retrieved in response to a search query. Even more specifically, each of a plurality of identified document is assigned a score based in whole or in part upon a degree of correlation between an Identified Personality Type for the user and Personality Usage Data associated with the document AND a degree of correlation between an Identified Age for the user and Age Usage Data associated with the document. The documents are then organized based at least in part upon the assigned scores. In this way the combined affect of a user's Personality and Age upon predicted document preference may be used to better order the documents in response to a search query. In some such embodiments Personality and Age correlations are equally weighted in their affect upon document ordering. In other embodiments, weighting factors are used such that Personality and Age correlations have differing amounts of affect upon document ordering.

Another aspect of the present invention is directed to a method for using all three of Identified Age Group, Identified Gender, and Identified Personality Type when ordering the documents presented to a user in response to a search query. In some such embodiments Personality, Age, and Gender correlations are equally weighted in their affect upon document ordering. In other embodiments, weighting factors are used such that Personality, Age, and Gender correlations have differing amounts of affect upon document ordering.

Another aspect of the present invention is directed to a method for defining and/or adjusting the Personality Correlation Factor for a user based upon a history of document preferences for the user and a correlation with the documents preferred by other users of certain identified personality characteristics. Another aspect of the present invention is directed to a method of predicting one or more characteristics of the Personality Type of a particular user based at least in part upon detected correlations between that user's document preferences and stored Personality Usage Data for a plurality of documents. These and other aspects of the invention will be described in detail with respect to the following description and figures:

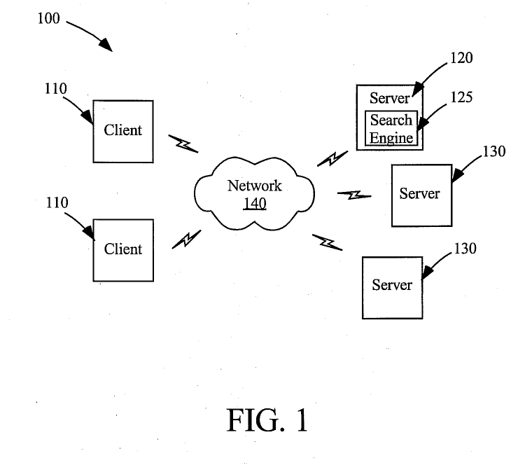

FIG. 1 illustrates a system 100 in which methods and apparatus, consistent with the present invention, may be implemented. The system 100 may include multiple client devices 110 connected to multiple servers 120 and 130 via a network 140. The network 140 may include a local area network (LAN), a wide area network (WAN), a telephone network, such as the Public Switched Telephone Network (PSTN), an intranet, the Internet, or a combination of networks. Two client devices 110 and three servers 120 and 130 have been illustrated as connected to network 140 for simplicity. In practice, there may be more or less client devices and servers. Also, in some instances, a client device may perform the functions of a server and a server may perform the functions of a client device.

The client devices 110 may include devices, such mainframes, minicomputers, personal computers, laptops, personal digital assistants, or the like, capable of connecting to the network 140. The client devices 110 may transmit data over the network 140 or receive data from the network 140 via a wired, wireless, or optical connection.

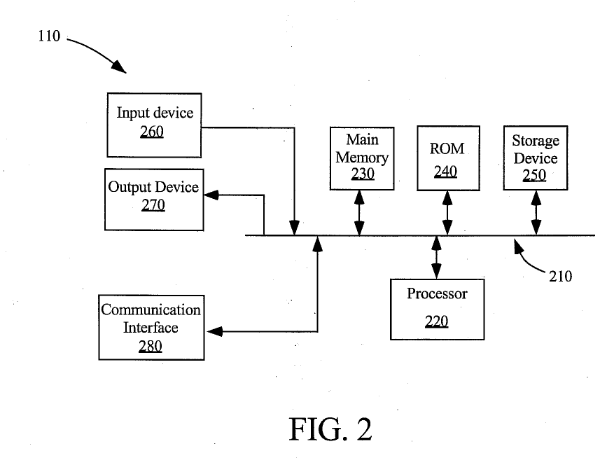

FIG. 2 illustrates an exemplary client device 110 consistent with the present invention. The client device 110 may include a bus 210, a processor 220, a main memory 230, a read only memory (ROM) 240, a storage device 250, an input device 260, an output device 270, and a communication interface 280.

The bus 210 may include one or more conventional buses that permit communication among the components of the client device 110. The processor 220 may include any type of conventional processor or microprocessor that interprets and executes instructions. The main memory 230 may include a random access memory (RAM) or another type of dynamic storage device that stores information and instructions for execution by the processor 220. The ROM 240 may include a conventional ROM device or another type of static storage device that stores static information and instructions for use by the processor 220. The storage device 250 may include a magnetic and/or optical recording medium and its corresponding drive.

The input device 260 may include one or more conventional mechanisms that permit a user to input information to the client device 110, such as a keyboard, a mouse, a pen, voice recognition and/or biometric mechanisms, etc. The output device 270 may include one or more conventional mechanisms that output information to the user, including a display, a printer, a speaker, etc. The communication interface 280 may include any transceiver-like mechanism that enables the client device 110 to communicate with other devices and/or systems. For example, the communication interface 280 may include mechanisms for communicating with another device or system via a network, such as network 140.

As will be described in detail below, the client devices 110, consistent with the present invention, may perform certain document retrieval operations. The client devices 110 may perform these operations in response to processor 220 executing software instructions contained in a computer-readable medium, such as memory 230. A computer-readable medium may be defined as one or more memory devices and/or carrier waves. The software instructions may be read into memory 230 from another computer-readable medium, such as the data storage device 250, or from another device via the communication interface 280. The software instructions contained in memory 230 causes processor 220 to perform search-related activities described below. Alternatively, hardwired circuitry may be used in place of or in combination with software instructions to implement processes consistent with the present invention. Thus, the present invention is not limited to any specific combination of hardware circuitry and software.

The servers 120 and 130 may include one or more types of computer systems, such as a mainframe, minicomputer, or personal computer, capable of connecting to the network 140 to enable servers 120 and 130 to communicate with the client devices 110. In alternative implementations, the servers 120 and 130 may include mechanisms for directly connecting to one or more client devices 110. The servers 120 and 130 may transmit data over network 140 or receive data from the network 140 via a wired, wireless, or optical connection.

The servers may be configured in a manner similar to that described above in reference to FIG. 2 for client device 110. In an implementation consistent with the present invention, the server 120 may include a search engine 125 usable by the client devices 110. The servers 130 may store documents (or web pages) accessible by the client devices 110 and may perform document retrieval and organization operations, as described below.

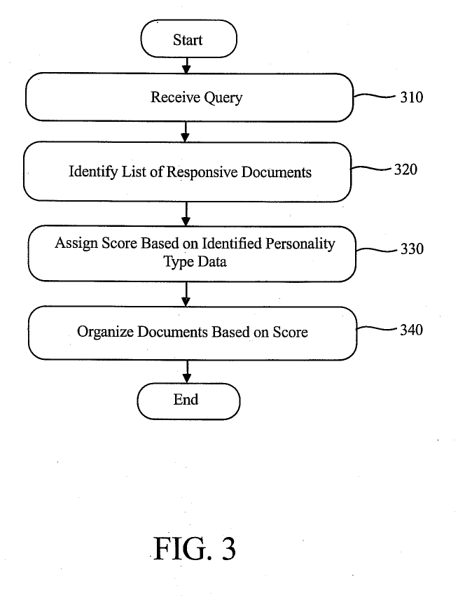

FIG. 3 illustrates a flow diagram, consistent with the invention, for organizing documents based on the Identified Personality Type of the user who performs a search and the Personality Usage Data for web documents that are retrieved during the search. At stage 310, a search query is received by search engine 125 as entered by said user. The query may contain text, audio, video, or graphical information. At stage 320, search engine 125 identifies a list of documents that are responsive (or relevant) to the search query. This identification of responsive documents may be performed in a variety of ways, consistent with the invention, including conventional ways such as comparing the search query to the content of the document.

Once this set of responsive documents has been determined, it is necessary to organize the documents in some manner. Consistent with the invention, this may be achieved by employing Identified Personality Type data, in whole or in part. Consistent with the invention this may be achieved also by employing Personality Usage Data, in whole or in part. In the particular embodiment represented by FIG. 3, this is achieved by employing both Identified Personality Type data and Personality Usage Data, in whole or in part.

As shown at stage 330, personality usage scores are assigned to each of a plurality of retrieved documents based upon how well the Personality Usage Data for a particular document correlates with the Identified Personality Type of the user who is performing the search. The scores may be absolute in value or relative to the scores for other documents. The scores are assigned based upon the level or degree of correlation determined. For example, a web site that has Personality Usage Data that shows heavy usage by SENSING users as compared to users from other personality classifications (i.e. INTUITIVE) will be determined to correlate strongly with a user who has an Identified Personality Type as SENSING. Alternately, a web site that has Personality Usage Data that shows low usage by SENSING users as compared to users from other personality classifications (i.e. INTUITIVE) will be determined to correlate weakly with a user who has an Identified Personality Type as SENSING. In this way, a higher score can be assigned to a document that shows a strong correlation between Personality Usage Data and Identified Personality Type of the user as compared to a document that shows weaker correlation between Personality Usage Data and Identified Personality Type of the user. In addition, a Personality Correlation Factor may be taken into account in the computation of such scores. For example, a user that has a high Personality Correlation Factor may have higher scores computed based upon a given correlation level between Personality Usage Data and Identified Personality Type as compared to a user who has a low Personality Correlation Factor value. In this way the documents may be scored based upon the correlation between Identified Personality Type of the user and the Personality Usage Data for the document, with optional consideration of a Personality Correlation Factor that represents the predictive value of personality correlation for the particular user who performed the search.

As a means of further example, in one exemplary embodiment a search query is entered by a user who is identified as ESTJ under a Myers-Briggs personality typing paradigm (i.e. Identified Personality Type=EXTROVERT, SENSING, THINKING, JUDGING). In response to this search query, the search engine finds a number of documents. Each of these documents has Personality Usage Data associated with it that indicates how often this document has been accessed in the recent past by users of various personality characteristics. For example, the Personality Usage Data may include a percentage for each of the four dichotomy assignments. In other words, each document may have usage data associated with it for PERCENT_EXTROVERT, PERCENT_SENSING, PERCENT_THINKING, and PERCENT_JUDGING). These percentages may be defined in a variety of ways, as described previously. In this particular example the percentages are the percentage of unique visitors who accessed the document over the last three months who had identified personality characteristic that fell into each of the four categories respectively. The percentages in this example are computed out of the total number of users who had identified personality characteristics. In this way, the currently example does not dilute the percentages with users who may have accessed the documents but did not have any identified personality characteristics.

Under this example model, one particular document has Personality Usage Data that indicates that the percentage of unique users who have access the document over the past 3 months and have identified personality characteristics showed the following percentages: PERCENT_EXTROVERT=47%, PERCENT_SENSING=48%, PERCENT_THINKING=52%, and PERCENT_JUDGING=82%. Thus for this particular document, about half the people who access were identified as Extroverts and about half were identified as Introverts. Similarly, about half were Sensing and about half were Intuitive. Similarly about half were Thinking and about half were Feeling. But for the last dichotomy, there is a more substantial statistical difference, with 82% having been identified as Judging and only 18% being identified as Perceiving. Thus for this particular document, a user who has an Identified Personality Type that includes the characteristic Judging, this particular document may be ordered substantially higher in the presented results than it would be for a user who performed the same search and had the identified personality characteristic of Perceiving.

Note—the above example analysis assumes that each of the two possible characteristics for each of the four dichotomies is present in equal numbers across the population. This may not actually be the case. For example, there may be far more Extroverts in the general population than Introverts. If this was the case, then the fact that 53% of the users who accessed the document in the above example were Introverts is actually an indicator that the particular document is likely to be highly preferred by Introverts. To account for such statistical effects a normalized value may be computed for each personality-based usage statistic, the normalized value accounting for the relative numbers of people who are known to have particular personality characteristics within a general population. As used herein Personality Usage Data may optionally include such normalized values to account for such statistical effects.

Thus returning attention to FIG. 3, the process of assigning a score at step 330 can be based on a variety of Personality Usage Data and Identified Personality Type data. In a preferred implementation, the Personality Usage information for a particular document comprises information about both the number of unique visits and the frequency of visits of users who are identified as having one or more particular personality characteristics. For example said Personality Usage Data may in some embodiments include data about not only how many unique visitors of a particular personality characteristic have visited an internet during a particular time period, but also the frequency. The values can be stored as absolute numbers, relative numbers, or percentages. In addition, in some implementations the data is normalized as described previously to account for the relative frequency of certain personality characteristics within the overall population.

The Personality Usage Data and Identified Personality Type data may be maintained at client 110 and transmitted to search engine 125. Alternately the Personality Usage Data may be maintained upon a server 130 and the Identified Personality Type data may be maintained upon client 110. Alternately both Personality Usage Data and Identified Personality Type data may be maintained upon a server 130. The location of the personality information is not critical, however, and it could also be maintained in other ways. For example, the Personality Usage Data may be maintained at servers 130, which forward the information to search engine 125; or the usage information may be maintained at server 120 if it provides access to the documents (e.g., as a web proxy).

Referring back to FIG. 3, at stage 340 the responsive documents are organized based on the assigned scores. The documents may be organized based entirely on the scores or may be organized based on the assigned scores in combination with other factors. For example, the documents may be organized based on the assigned scores combined with link information and/or query information. Link information involves the relationships between linked documents, and an example of the use of such link information is described in the Brin & Page publication referenced above. Query information involves the information provided as part of the search query, which may be used in a variety of ways to determine the relevance of a document. Other information, such as the length of the path of a document, could also be used. In addition, the relative importance of the personality score with the other factors used in ordering the documents is a variable that may be set, assigned, or derived. In addition, general usage data that indicates the total number of users who visit particular documents (as absolute or relative values) may be used in combination with the personality based usage information described herein. In addition, it is anticipated that some documents may not have Personality Usage Data associated with it because, for example, the document is new and has not yet been visited by users. In such embodiments the document may not be assigned a score OR may be identified a nominal score. Alternately the document may be assigned nominal Personality Usage Data values.

In some preferred embodiments of the present invention, the relative importance of a personality usage score as compared to other factors used in ordering the document is based in whole or in part upon a Personality Correlation Factor value that is relationally associated with the user who performed the search. In such embodiments the affect that personality usage score has upon ordering of the document as compared to the affect that other factors have upon ordering of the documents is dependent upon the Personality Correlation Factor, the higher the Personality Correlation Factor, the greater the affect that personality usage score has as compared to other factors used in ordering.

In one implementation, documents are organized based on a total score that represents the product of a personality usage score and a standard query-term-based score (“IR score”). The personality usage score may be weighted based upon the Personality Correlation Factor prior to computation of the total score. In some embodiments the total score equals the square root of the IR score multiplied by the weighted personality usage score. In this way traditional factors may be used in combination with personality usage scores when ordering documents. In some implementations a plurality of usage factors may be used in combination. For example, in one implementation documents are organized based on a total score that represents the product of a personality usage score and a gender usage score and an age usage score and a standard query-term-based score (“IR score”). A variety of different methods may be used for computing scores based upon such a combination of factors.

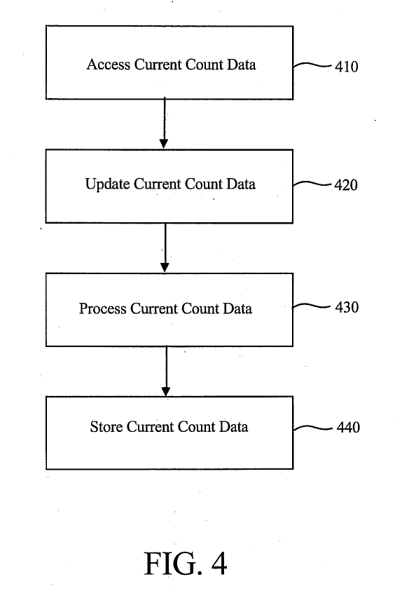

FIG. 4 illustrates a few techniques for computing the number and/or frequency of visits to a web document by users who have an Identified Personality Type that contains a particular personality characteristic (or particular grouping of personality characteristics). The computation begins with a plurality of current count variables being accessed at 410, one of which may be a total count. This total count may be an absolute or relative number corresponding to the overall visit count or visit frequency for the document. For example, the total count may represent the total number of times that a document has been visited by users. Alternatively, the total count may represent the number of times that a document has been visited in a given period of time (e.g., over the past week), the change in the number of times that a documents has been visited in a given period of time (e.g., 20% increase during this week compared to the last week), or any number of different ways to measure how many times and/or how frequently over time a document has been visited overall.

In addition to or instead of the total count values described above at 410, one or more Personality Counts are also accessed at 410 for each of a plurality of tracked personality characteristics or groupings of personality characteristics. Said personality counts may be an absolute or relative number corresponding to the visit count and/or visit frequency of users who previously visited the document who have a particular personality characteristic and/or grouping of personality characteristics identified for them. For example, a particular embodiment is configured to track visiting users based on each of eight different personality characteristics, each corresponding to one of the Myers Briggs personality classifications (i.e. EXTRAVERTED, INTROVERTED, SENSING, INTUITIVE, THINKING, FEELING, JUDGING, and PERCEIVING). An alternate example embodiment is configured to track users based upon particular combinations of identified personality characteristics, for example each of the sixteen combinations of dichotomy assessments that are possible under the Myers Briggs personality classification paradigm. These are generally represented as (ISTJ ISFJ INFJ INTJ ISTP ISFP INFP INTP ESTP ESFP ENFP ENTP ESTJ ESFJ ENFJ ENTJ) where I stands for INTROVERTED, E stands for EXTROVERTED, S stands for SENSING, N stands for INTUITIVE, T stands for THINKING, J stands for JUDGING, P stands for PERCEIVING, F stands for FEELING. An alternate example embodiment is configured to track each of four dichotomy assessments of the Myers Briggs personality classification paradigm. For example (I/E, S/N, T/F, J/P) using the letter codes described above.

For the sake of simplicity of explanation, consider the example above in which each of eight different personality characteristics are tracked by a separate personality count for a given document. Each of the personality counts are accessed at 410 and corresponds to the number and/or frequency of visits to the document from users who possess a particular one of the eight different personality classifications. For example, eight separate personality counts may be accessed at 410, each one tracking the visits by users who posses each of EXTRAVERTED, INTROVERTED, SENSING, INTUITIVE, THINKING, FEELING, JUDGING, and PERCEIVING personality classifications. In some embodiments counts may be defined for specific combinations of personality characteristics. Also, in some embodiments a plurality of counts may be maintained for each personality characteristic, including for example a cumulative count for that personality characteristic and a frequency count (i.e. a count per unit time) for that personality characteristic.

In some embodiments, all available counts are accessed at 410. In other embodiments only counts that need to be updated are accessed at 410. For example a Total Count may be accessed at 410 as well as a personality counts for those specific personality characteristics or groups of characteristics that are reflected within the Identified Personality Type data of the current user. For example if the Identified Personality Type data of a user visiting a specific document is identified as including the characteristic JUDGING, a personality count associated with the personality characteristic JUDGING would be accessed at 410. A total count may also be accessed at 410 in this example embodiment.

The process then proceeds to step 420 wherein the count values are updated in response to the current user visit. In general the total count is increased by one visit. In addition the personality count values associated with each tracked personality characteristic and/or grouping of personality characteristics that is reflected in the current user's Personality Type data is increased by one visit. For example if the Identified Personality Type of a user visiting a specific document is EXTRAVERTED, SENSING, JUDGING, and THINKING, one or more personality counts associated with each of the characteristics EXTRAVERTED, SENSING, JUDGING, and THINKING is increased by one visit. In this way personality count variables can be accessed and incremented, tallying the number and/or frequency of visitors to the document who are identified as having a particular personality characteristic. Alternatively, the count may represent the number of times that a document has been visited by users who are identified as having one or more particular personality characteristic during a given period of time (e.g., over the past week), the change in the number of times that a documents has been visited by users who are identified as a having one or more particular personality characteristic during a given period of time (e.g., 20% increase during this week compared to the last week), or any number of different ways to measure how many times and/or how frequently a document has been visited by users who have Identified Personality Type data that indicates they have one or more personality characteristics that are being tracked, either independently or as part of a grouping or tracked characteristics.

In other implementations, the total count and/or each of the personality counts may be processed at 430 using any of a variety of techniques to develop a refined visit frequency for each. For example, the total count and/or one or more personality counts may be filtered to remove certain visits. For example, one may wish to remove visits by automated agents or by those affiliated with the document at issue, since such visits may be deemed to not represent objective usage. In some embodiments only unique visits are counted within a given time period—for example if the same user visits a document multiple times within a given time period, the count may be incremented only by one visit for that user. The identification of the unique users may be achieved based on the user's Internet Protocol (IP) address, their hostname, cookie information, or other user or machine identification information. In addition, the visit count and/or visit frequency data may be normalized as described previously. At the final step 440 in FIG. 4, the updated visit data, including the personality type visit data, is stored for later access.

Although only a few techniques for computing the visit counts and/or visit frequencies are illustrated in FIG. 4, those skilled in the art will recognize that there exist other ways for computing the number and/or frequency of visits by users of particular identified personality characteristics or groupings of identified personality characteristics consistent with the invention. Furthermore although FIG. 4 illustrates the determination of Personality Usage Data on a document-by-document basis, other techniques may be used. For example, rather than maintaining Personality Usage Data for each document, one could maintain such information on a site-by-site basis. This site-based Personality Usage information could then be associated with some or all of the documents within that site. This reduces the amount of data that must be stored for each site. In addition, the Personality Usage Data may be normalized as described previously.

It should also be noted that the process described in FIG. 4 may be used for other forms of specialized usage data as referenced herein, including Gender Usage Data and Age Usage Data. In this way other unique forms of usage data may be accessed, updated, processed, and stored, thereby maintaining statistics that reflect the visit behavior to a particular document with respect to user personality type, user gender, and/or user age. These three variables are particularly useful in combination when ordering documents in response to a search query, for personality type, age, and gender describe highly targeted demographic groups that often have statistically similar document preferences. In some embodiments any two of gender, age, and personality type, may be used in combination to order documents in response to a search query. The benefits of using Age and Gender alone are described in co-pending U.S. application Ser. No. 11/341,021 which has been incorporated herein by reference.

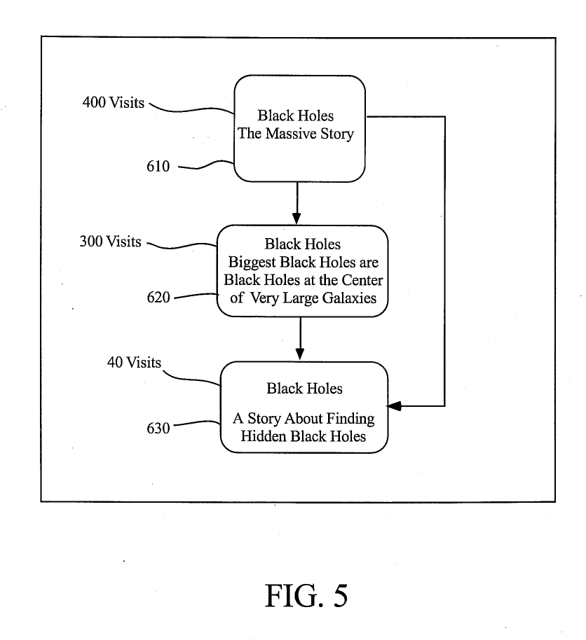

FIG. 5 depicts an exemplary method employing visit frequency information, consistent with certain embodiments of the present invention. As shown, three documents, 610, 620, and 630 are depicted which are responsive to a search query for the term “black holes”. Document 610 is shown to have been visited 400 times over the past month, with 150 of those 400 visits being by automated agents. Of the 250 non-automated visits, this document is shown to have been visited 100 times by users who have Identified Personality Type Data identifying them as THINKING, visited 130 times by users who have Identified Personality Type Data identifying them as FEELING, and 20 times by users of Identified Personality Type Data identifying them as NEUTRAL on the thinking/feeling personality dichotomy assessment. By neutral it is meant that either the user has not been assessed on this particular personality metric or that previous assessments found the user not to be biased enough towards either of THINKING or FEELING to make a clear determination.

Document 620, which is linked to from document 610, is shown to have been visited 300 times over the past month, all non-automated. Of the 300 visits, this document is shown to have been visited 210 times by users who have Identified Personality Type Data indicating that they are THINKING, visited by 60 times by users by users who have Identified Personality Type Data indicating that they are FEELING, and visited by 30 users of NEUTRAL status for the thinking/feeling personality dichotomy assessment.

Document 630, which is linked to from documents 610 and 620, is shown to have been visited 40 times over the past month, all non-automated. Of the 40 visits, this document is shown to have been visited 10 times by users who have Identified Personality Type Data indicating that they are THINKING, visited by 20 times by users who have Identified Personality Type Data indicating that they are FEELING, and visited by 10 users of NEUTRAL status for the thinking/feeling personality dichotomy assessment.

It should be noted that the visit numbers above may be normalized values in some embodiments as described previously. Such a normalization process takes into account the relative populations and/or numbers of internet users and/or the relative amount of internet use among a plurality of the tracked personality characteristics. This would be used, for example, if there were substantially more users in the overall population of internet users who were identified as THINKING as compared to FEELING (or vice versa).

The next step is to order the documents. Under a conventional term frequency based search method, the documents may be organized based on the frequency with which the search query term (“black holes”) appears in the document. Accordingly, the documents may be organized into the following order: 620 (assuming three occurrences of “black holes” were found), 630 (assuming two occurrences of “black holes” were found), and 610 (assuming one occurrence of “black holes” were found).

Under a conventional link-based search method, the documents may be organized based on the number of other documents that link to those documents. Accordingly, the documents may be organized into the following order: 630 (linked to by two other documents), 620 (linked to by one other document), and 610 (linked to by no other documents).

Under a conventional visit count method of organizing documents, the documents may be organized based upon the total number of visits to that site by non-automated agents. Accordingly, the documents may be organized into the following order 620 (visited by 300 non-automated agents), 610 (visited by 250 non-automated agents), then 630 (visited by 40 non-automated agents).

Methods and apparatus consistent with the present invention employ both Identified Personality Type data and Personality Usage Data (optionally including normalized values in many preferred embodiments) to aid in organizing documents retrieved in response to an internet search. In this case, the methods determine from the Identified Personality Type data of the user who is currently performing the search that he or she has the identified personality characteristic of FEELING. The documents retrieved are then organized at least in part upon the Identified Personality Type of the user who is performing the search and historical data indicating the number and/or percentage and/or frequency of visits to the retrieved documents by other users who were also identified as having the same personality characteristic(s) or a set of characteristics that falls within the same defined grouping of personality characteristics. Thus in this example, the documents retrieved are organized based at least in part upon the fact that the searching user is FEELING as correlated with Personality Usage Data that indicates the relative number and/or percentage, and/or frequency of previous users who have accessed some or all of said documents and were also identified as FEELING.

Referring back to FIG. 5, the methods of the present invention may order example documents listed based upon one or more identified personality characteristics of the user (i.e. FEELING) and the Personality Usage Data listed for the documents in the figure. Thus in this example, the documents are organized based upon the percentage of FEELING users who visited each document in the past as compared to users of other personality characteristics (i.e. THINKING). In this example, NEUTRAL users are not counted because they are not predictive in either direction. Using such a method, the documents may be ordered in the following way: 630 (67% of the users who previously visited the document were identified as FEELING), 610 (57% of the users who previously visited the document were identified as FEELING), and then 620 (22% of the users who previously visited the document were identified as FEELING). Thus the documents are presented to the user with 630 first, then 610, and then 620.

This is different than how the documents would have been ordered using the same analysis but for a searching user who was identified as THINKING. A user of THINKING personality classification, for example, may have been presented with the documents in the order 620, 610, 630, based upon the percentages of prior visits by users of THINKING personality classification.

Note—instead of using only the Identified Personality Type data of the user and the Personality Usage Data for the documents, the Personality data may be used in combination with the query information and/or the link information to develop the ultimate organization of the documents. Also, the personality analysis may also be used in combination with total count usage data, such total count data indicating the overall popularity of the document among users of all personality characteristics. In such a case, for example, document 630 may be ordered lower in the listing because the total visit count for that document is so much less than the total visit count for the other documents.

Personality/Gender/Age Combinations: In some embodiments of the present invention, Personality and Age and Gender correlations may be used simultaneously to provide an even more refined ordering of documents for a user of particular personality, gender, and age, combinations. For example, for an INTUITIVE user who is MALE and of AGE GROUP between 19 and 25 years old performs an internet search using the methods disclosed herein. The user's Identified Personality Type and Identified GENDER and Identified AGE is correlated with Personality Usage Data, Gender Usage Data, and Age Usage Data respectively to determine the level of match. In this way the ordering process considers in whole or in part how often a particular document has been accessed in the past by users who were also INTUITIVE and MALE and of an AGE GROUP between 19 and 25 years old. Again, any two of these three may be used in combination as well. In addition, these three factors may be used with other factors such as total usage counts and/or query information and/or link information.

Additional Methods

Entering Data: As used herein, the software of the present invention has access to Identified Personality Type data for users who perform searches. This data may be collected in a variety of ways, for example at the time the search is performed or during a previous registration stage and stored with relational association to a user specific ID. In some common embodiments the users answer questions as part of an automated testing procedure for personality typing. A wide range of internet-based personality typing questionnaires are available over the internet. One such test is provided at the web site called HUMANMETRICS at http://www.humanmetrics.com/cgi-win/JTypes2.asp which is hereby incorporated by reference. The results from such a test could be provided manually and/or automatically to the processes described herein for incorporation into Identified Personality Type data for a particular user. In addition to answering questions and/or responding to queries to provide personality related information, the user may enter his or her gender, age, birth year, birth date, or age group by selecting choices from a user interface or by responding to a query. In some embodiments, personality information from a user is accessed from a separate database that maintains such information for a plurality of users. Similarly, in some embodiments age and gender information are accessed from a separate database that maintains such information for a plurality of users.

User Ratings: In addition to tracking how many and/or how often users of particular personality characteristic(s) access a given document or site (as disclosed in the pages above), the invention disclosed herein includes further methods to allow said users to rate web-documents, said ratings being correlated with the users Identified Personality Type data. Said ratings can optionally be prompted by the search engine, asking the user to rate the usefulness of the document after it has been reviewed by the user. The rating can be binary (useful/not-useful) or can be given on a continuous rating scale, for example a Usefulness Rating Scale from 1 to 10 (1 being the least useful and 10 being the most useful). In this way a user who is, for example, FEELING and searches for information about THE CIVIL WAR can rate the documents he reviews, said rating information being added to the Personality Usage Data store for each document. Using the methods and systems disclosed herein, the Personality Usage Data correlates the rating data given by the user with that user's personality characteristics. In this way the Personality Usage Data for the CIVIL WAR related documents described above will be updated with the rating information given by users of various personality characteristics. For example, the average usefulness rating provided by FEELING users about a particular Civil War document upon a Usefulness Scale from 1 to 10 (with 1 being the least useful and 10 being the most useful) may be 8.5 on the scale. Similarly, the average usefulness rating provided by THINKING users for the same Civil War document upon a Usefulness Scale from 1 to 10 (with 1 being the least useful and 10 being the most useful) may be 2.5 on the scale. Thus the document is shown to be highly useful by users of FEELING personality and minimally useful by user of THINKING personality. This data may then be used to strengthen the correlation of this document to FEELING personality type data and to weaken the correlation of this document to THINKING personality type data. For example, the Personality Usage Data representing the relative number and/or frequency of FEELING visitors may be scaled upward based upon the highly useful rating data provided by FEELING users. Similarly, the Personality Usage Data representing the relative number or frequency of THINKING visitors may be scaled downward based upon the minimally useful rating data provided by THINKING users. In this way rating data provides more accurate means for correlation between Personality Usage Data and Identified Personality Type data to predict the usefulness of a given document to a particular user performing a search.

Other Rating Methods: In some embodiments, other methods may be used to derive “usefulness” rating data other than simply collecting data from the user as a result of a direct query. For example Print Tracking is a technique that may be employed as is disclosed in pending U.S. patent application Ser. No. 11/298,797 which has been incorporated by reference. Similarly, Time Spent tracking is a technique that may be employed as is also disclosed in application Ser. No. 11/298,797.

Assigned Personality Correlations—in addition to, or instead of Personality Usage Data reflecting the number of users and/or frequency of users who have visited a document of a particular identified personality characteristic(s), an Assigned Personality Correlation may be set for a particular web site, said Assigned Personality Correlation reflecting the likely relevance of that site to a user of particular Identified Personality Type data. For example a website could be assigned a high correlation factor with JUDGING users. This assigned correlation could be set by an author of the web document, an owner of the web document, the host of the web document, or by some other party. The assigned correlation could be stored on the server along with the document itself or could be stored on a remote server or proxy server. In some embodiments of the invention disclosed herein, the Assigned Personality Correlation is used by the ordering algorithm, more favorably ordering those documents that have an Assigned Personality Correlation that correlate well with Identified Personality Type data of the user who initiated a given search. In some such embodiments the Assigned Personality Correlation may include an assignment for a plurality of different personality metrics, for example an assignment for multiple of the four dichotomy assessments of a typical Myers Briggs paradigm. In such a model, for example, a particular document may be assigned both JUDGING and FEELING, thereby describing the particular combination of factors that are most likely to predict user preference of the document. In such an example, those users who possess both of the factors may be presented the document with higher ordering than users who possess only one of the factors. Similarly, those users who posses one of the factors will be presented the document with higher ordering than users who possess neither of the factors.

Predicting the Personality of an Unknown User: There are some situations in wherein a user enters a query into a search engine but the search engine does not have access to Identified Personality Type data for the user. For example, the user may have refused or neglected to enter personality related data into the system. A benefit of the methods and apparatus of the present invention is that it provides a computational infrastructure within which one or more personality characteristics of a user may be predicted based upon previously collected Personality Usage Data from other users and data reflecting the current and/or historical document visiting habits of the current user of unknown personality typing. Thus the present invention provides for a novel method of assessing the personality characteristics of a user based upon their document preference as correlated with the document preferences of previous users of known personality types.

Using the methods and apparatus as disclosed herein, the personality characteristics of a user of unknown personality type can be predicted by correlating the documents that he or she is currently visiting and/or has historically visited with the Personality Usage Data for those documents. For example, if a user has recently visited ten web documents, each of those documents having Personality Usage Data showing a strong correlation with an Identified Personality Type of PERCEIVING, the software of the present invention may predict that the current user of unknown personality is PERCEIVING in nature. Furthermore the software of the present invention may assign an Identified Personality Type to that unknown user that includes a PERCEIVING identification. Because the Personality was predicted and not provided by the user directly through a formal query or testing process, the Personality Correlation Factor for that user may be set initially to a low value. As the user visits additional sites, those sites also having with Personality Usage Data that are strongly correlated with PERCEIVING users, the software routines of the present invention may increase the Personality Correlation Factor for the given user. In this way the present invention may predict one or more personality typing characteristics for a user based upon the Personality Usage Data stored for sites and/or documents that the user visits. In addition, the software routines of the present invention may assign and/or adjust the prediction and/or the associated Personality Correlation Factor based upon the degree of correlation of the Personality Usage Data for web sites and/or documents that the user visits over a period of time with the predicted personality characteristic(s) of the user. Note—the prediction process may be more effective when normalized values are used at least as part of the Personality Usage Data used in the prediction process because this accounts for the relative size of the total populations of users of certain personality characteristics.

Thus the software of the present invention may assign Identified Personality Type data to a user of unknown personality characteristics based upon the Personality Usage Data stored for documents that the user visits or has visited in the recent past. In one example, a user of unknown personality visits a number of documents, each of which is associated with Personality Usage Data. A mean or average value of Personality Usage Data may be computed across the number of documents that the user visited. For example, in one embodiment Average Personality Counts may be computed for the number of documents that the user visited, the Average Personality Counts being the statistical average of Personality Usage Data associated with each of the number of documents visited. This average value may indicate a central trend—indicating for example if, on average, the user has visited sites that are favored significantly more by users of some tracked personality characteristics (or groupings of characteristics) as compared to others. Other statistical methods may be used to identify central trends among the Personality Usage Data of documents visited by the user over a certain period of time. For example, histogram methods may be used.

Note—in some embodiments user rating data stored within the Personality Usage Data for given documents may be used as part of the user personality prediction process. For example, a if a set of historical documents accessed by a particular user are determined to have, on average, user rating values that are high for visiting users of a particular personality characteristic, the particular user may be predicted to also have that particular personality characteristic.

In some embodiments of the present invention the Predicted Personality of a user (determined for example based upon a computed central tendency of the Personality Usage Data of a plurality of documents visited by that user over a period of time) may be used to derive an Identified Personality Type for that user when a search query is received by that user and documents are to be ordered. Thus the methods as disclosed herein for ordering documents based upon an Identified Personality Type for a user who performs a search query may be performed using a Predicted Personality for the user who performs the search.

Thus using the methods and apparatus described herein, one or more personality characteristics of a user may be predicted based upon the documents that a user visits in combination with additional data such as Personality Usage Data and/or Assigned Personality Correlation data for those documents. The predicted Personality may then be used by the methods of the present invention to better order documents retrieved in response to a search query entered by the user.

Overall the present invention enables a plurality of documents that are retrieved in response to a search query to be ordered based at least in part upon an Identified Personality Type for the user who performs the search used in combination with statistical data indicating how user preference to the retrieved documents may vary with user personality typing data. In some embodiments Identified Personality Type is used in combination with an Identified Age and/or Identified Gender of a user when ordering document in response to a research query from said user. As also described herein, related methods may be used to predict the personality typing of a user of unknown personality based upon a history of documents accessed by the user used in combination with statistical data indicating how user preference to the accessed documents may vary with user personality data.

While the invention herein disclosed has been described by means of specific embodiments, examples and applications thereof, numerous modifications and variations could be made thereto by those skilled in the art without departing from the scope of the invention set forth in the claims.

What is claimed is:

1. A computer implemented method of organizing a set of documents retrieved in response to a search query, the method comprising:
receiving a search query from a user;
obtaining an identified personality type for the user, the identified personality type classifying the user with respect to one or more personality characteristics;
identifying a set of documents responsive to the search query;
assigning a score to each identified document based upon a correlation between personality-usage data for each document and the identified-personality type of the user, the personality-usage data for each document describing at least one of a number, frequency, and percentage of users who have previously accessed the document who are deemed to possess one or more particular personality characteristic classifications; and
organizing the documents based at least in part on the assigned score.

2. The method of claim 1 wherein the one or more personality characteristics include one or more Myers-Briggs personality characteristics.

3. The method of claim 1 wherein the one or more personality characteristics includes an indication of whether the user can be described more as an introvert or extrovert.

4. The method of claim 1 wherein the one or more personality characteristics includes an indication of whether the user is more likely to be partial to quantitative or qualitative information.

5. The method of claim 1 wherein the one or more personality characteristics includes an indication of whether the user is more likely to be partial to facts or feelings.

6. The method of claim 1 wherein the one or more personality characteristics includes an indication of whether the user can be described more as judging or perceiving.

7. The method of claim 1 wherein the one or more personality characteristics includes a personality assignment for the user with respect to each of a plurality of distinct personality dichotomies.

8. The method of claim 1 wherein the personality usage data includes a representation of at least one of the number, frequency, and percentage of users who previously accessed the document during a particular prior period of time who were deemed to possess one or more particular personality characteristics classifications.

9. The method of claim 1 wherein the identified personality type of the user is derived based upon results of a personality test taken by the user.

10. The method of claim 1 further comprising:
assigning a score to each identified document further comprises assigning a score based at least in part upon a personality correlation factor;
wherein the identified personality type of the user further includes the personality correlation factor indicating a degree of statistical relevance that one or more personality characteristic classifications has on predicting document preference for the user.

11. The method of claim 1 further comprising:
obtaining identified-gender data for the user, the identified-gender data including information describing a gender of the user;
wherein the step of assigning a score to each identified document further comprises assigning a score based at least in part upon a correlation between gender-usage data for each document and the identified-gender data, the gender-usage data describing at least one of a number, frequency, and percentage, of users who have previously accessed the document who are of a particular gender.

12. The method of claim 1 further comprising:
obtaining identified-age data for the user, the identified-age data including information describing an age or age range of the user;
wherein the step of assigning a score to each identified document further comprises assigning a score based at least in part upon a correlation between age-usage data for each document and the identified-age data, the age-usage data describing at least one of a number, frequency, and percentage, of users who have previously accessed the document who are of a particular age or age range.

13. The method of claim 1 wherein the personality-usage data for each document includes rating data for that document, the rating data indicating a reported level of usefulness of the identified document to one or more previous users who accessed the document and who were deemed to possess one or more particular personality characteristic classifications.

14. A computer implemented method of organizing a set of documents retrieved in response to a search query, the method comprising:
receiving a search query from a user;
obtaining identified personality type data for the user, the identified personality type data classifying the user with respect to one or more personality characteristics;
identifying a set of documents responsive to the search query;
assigning a score to each identified document based upon a correlation between the identified-personality type data of the user and stored data associated with the document, the stored data indicating how user partiality towards the document is likely to be influenced by one or more user personality characteristic classifications; and
organizing the documents based at least in part on the assigned score.

15. The method of claim 14 wherein the one or more personality characteristics include one or more Myers-Briggs personality characteristics.

16. The method of claim 14 wherein the one or more personality characteristics includes an indication of whether the user can be described more as an introvert or extrovert.

17. The method of claim 14 wherein the one or more personality characteristics includes an indication of whether the user is more likely to be partial to quantitative or qualitative information.

18. The method of claim 14 wherein the one or more personality characteristics includes an indication of whether the user is more likely to be partial to facts or feelings.

19. The method of claim 14 wherein the stored data includes a representation of at least one of the number, frequency, and percentage of users who previously accessed the document during a particular prior period of time who were deemed to possess one or more particular personality characteristic classifications.

20. The method of claim 14 wherein the identified personality type data of the user is derived based upon results of a personality test taken by the user.

21. The method of claim 14 wherein:
the identified personality type data of the user further includes a personality correlation factor indicating a degree of statistical relevance that one or more personality characteristic classifications has on predicting document preference for the user; and
the step of assigning a score to each identified document further comprises assigning a score based at least in part upon the personality-correlation factor.

22. The method of claim 14 further comprising:
obtaining identified-gender data for the user, the identified-gender data including information describing a gender of the user;
wherein the step of assigning a score to each identified document further comprises assigning a score based at least in part upon a correlation between the identified-gender data for the user and gender data associated with the document, the gender data associated with the document indicating how user partiality towards the document is likely to be influenced by user gender.

23. The method of claim 14 further comprising:
obtaining identified-age data for the user, the identified-age data including information describing an age or age range of the user;
wherein the step of assigning a score to each identified document further comprises assigning a score based at least in part upon a correlation between the identified-age data for the user and age-data associated with the document, the age-data associated with the document indicating how user partiality towards the document is likely to be influenced by user age or age range.

24. A computer implemented method of organizing a set of documents retrieved in response to a search query, the method comprising:
receiving a search query from a user;
obtaining identified personality type data for the user, the identified personality type data classifying the user with respect to one or more personality characteristics;
identifying a set of documents responsive to the search query;
assigning a score to each identified document based upon a correlation between the identified-personality type data of the user and stored data associated with the document, the correlation indicating a degree of partiality that the user is likely to have towards the document as a result of the user's classification with respect to one or more personality characteristics.

25. The method of claim 24 wherein the one or more personality characteristics include one or more Myers-Briggs personality characteristics.
